(19) United States
(12) Patent Application Publication
(10) Pub. No.: US 2004/0059629 A1
(43) Pub. Date: Mar. 25, 2004

(54) System and method to monitor materials containing smart tags to generate business intelligence

(75) Inventors: Yingdong Luo, Bethesda, MD (US); Tao Li, Montreal (CA)

Correspondence Address: STERNE, KESSLER, GOLDSTEIN & FOX PLLC, 1100 NEW YORK AVENUE, N.W., WASHINGTON, DC, 20005, US

(73) Assignee: I.E. Control Solutions, Inc.

(21) Appl. No.: 10/247,290

(22) Filed: Sep. 20, 2002

Related U.S. Application Data
(60) Provisional application No. 60/400,098, filed on Aug. 2, 2002.

(51) Int. Cl. G06F 17/60

(52) U.S. Cl. 705/14

(57) ABSTRACT

A system and method that generate marketing intelligence by auditing the effectiveness of different segments of a cross platform marketing device. The system and method allow for coordinated media for marketing purposes. The coordinated media can include graphical displays, textual displays, and various pockets holding marketing materials with embedded smart tags or smart labels. The displays can cyclically change what products or offers are displayed. Each displayed product can be linked to one or more of the materials in specific pockets. In this manner, when a product or offer is shown and a predetermined number of marketing materials are taken from the specific pocket, marketing intelligence is generated as to the effectiveness of the display and the marketing materials based partially on the smart tags or labels. The marketing materials can be a coupon or voucher. When this is the case, additional intelligence is generated based on when and where the marketing materials are redeemed based partially on the smart tags or labels. All the intelligence is used to better coordinate the media, better schedule production of the printed marketing media, and better determine costs and effectiveness of marketing media. The marketing intelligence can be generated in “real time.”

### CROSS-REFERENCE TO RELATED APPLICATIONS

This application claims priority under 35 U.S.C. §119(e) to U.S. Provisional Appl. No. 60/400,098 filed Aug. 2, 2002, which is incorporated by reference herein in its entirety.

### BACKGROUND OF THE INVENTION

1. Field of the Invention

The present invention is directed to systems and methods for generating marketing intelligence.

2. Background Art

In today's capitalistic environment competition is fierce, which drives up marketing costs. More companies are marketing more products in more ways than anytime in our history. Products and services are being marketed through advertisements or through direct marketing methods such as direct mail and telemarketing. One of the more effective ways of marketing is to use point-of-sale (POS) or point-of-purchase (POP) displays for items either in that location or at other locations, or using the public venues such as hotel and airport lounge lobbies to promote products. Marketing materials distributed through POS and POP are usually informational flyers or redeemable coupons or vouchers. The cost to design, manufacture, and distribute these items increases exponentially each year. Adding to that is the costs and time to inventory and maintain supplies of these products, which are both burdensome and expensive in terms of materials and person hours. A new trend is emerging of using displays such as LCD, TV monitors in public places to do promotions by casting messages in digital format. The difficulty facing is how to effectively audit and measure the effectiveness of such a new media.

Therefore, what is needed is a system and method than can automatically keep track of effectiveness of a digital marketing platform that is located in public venues cost-effectively, distributed marketing materials in an unattended way.

### BRIEF SUMMARY OF THE INVENTION

Embodiments of the present invention provide a system including digital media casting portion from which promotional messages in various formats to be, and a distribution portion from which materials having smart tags are distributed. The system also includes a redemption portion at which the materials having smart tags are redeemed. The system further includes a processing portion that processes information received from the distribution portion and the redemption portion and that transmits result information to the distribution portion.

Other embodiments of the present invention provide a system including a processing portion and a distribution portion that communicates with the processing portion. The distribution portion includes a display device, a holding device that holds material having smart labels, and a reading device that reads the smart labels.

Still other embodiments of the present invention provide a method including collecting data relating to information output from a display device, collecting data relating to materials having smart labels during insertion, distribution, and redemption of the materials, and generating intelligence data from the collecting steps.

Still further embodiments of the present invention provide a method including collecting data relating to information output from a display device, collecting data relating to materials having smart labels during insertion and distribution of the materials, and generating intelligence data from the collecting steps.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an example system used during distribution of materials and processing of information to generate marketing intelligence, according to embodiments of the present invention.

FIG. 2 shows a distribution portion of the system of FIG. 1.

FIG. 3 shows an example system used during redemption of the materials distributed in FIG. 1 and processing of information to generate marketing intelligence, according to embodiments of the present invention.

FIG. 4 is a flow chart depicting a method to generate marketing intelligence, according to embodiments of the present invention.

FIG. 5 is a flow chart depicting a method to generate marketing intelligence, according to other embodiments of the present invention.

FIG. 6 depicts a computer system, according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Overall Systems and Methods

Embodiments of the present invention are directed to a system and method used to generate marketing intelligence by auditing the effectiveness of different segments of a cross platform marketing device. The system and method allow for coordinated media for marketing purposes. The coordinated media can include graphical displays, video displays, textual displays, audio output and various pockets holding marketing materials with embedded smart tags or smart labels. The displays can cyclically change what products, services, or offers (hereafter collectively referred to as “offerings”) are displayed. Each displayed offering and/or audio output can be linked to one or more of the materials in specific pockets. In this manner, when an offering is shown and a predetermined number of marketing materials are taken from the specific pocket, marketing intelligence is generated as to the effectiveness of the display and the marketing materials based partially on the smart tags (labels). The marketing materials can be a coupon, voucher, or the like. When this is the case, additional intelligence is generated based on when and where the marketing materials are redeemed based partially on the smart tags or labels. All the intelligence is used to better coordinate the media, better schedule production of the printed marketing media, and better determine costs and effectiveness of marketing media. The marketing intelligence can be generated in “real time.” In some embodiments, real time is defined to mean 12 hours for processing and another 12 hours for forwarding. In other embodiments, the meaning of real time various based on the environment and demands required for the information.

Throughout the specification, “materials” can be marketing brochures, marketing flyers, coupons, vouchers, sample products, CD ROMS, DVD's, diskettes, or any other object that can include an embedded or otherwise coupled smart tag or label.

Throughout the specification, the use of “smart tags” or “smart labels” can refer to radio frequency identification (RFID) technology. RFID technology combines an integrated circuit with an RF antenna to deliver a tag that can simultaneously store and process information about an object it is associated with. The smart tags or labels are normally embedded in an object. Thus, smart tags or labels can be used to track, control, and manage almost anything quickly without being seen by a person handling the object. All known or future developed varieties of smart tags or labels are contemplated within the scope of the present invention.

Throughout the specification, the use of “marketing intelligence” refers to any data or information that can be gathered, calculated, or otherwise come by, which allows a company to audit the effectiveness of each segment of a coordinated marketing media. Throughout the specification, the use of “real time” in reference to the generation of marketing intelligence can be any amount of time specified to process and forward the information. For example, 12 hours to process and 12 hours to forward. Also, although shown and discussed primarily in relation to a network (e.g., internet or intranet) based system and method, it can be a stand along system and method for use at a single location. If a network is used, any transmission control protocol/internet protocol (TCP/IP) based network is contemplated within the scope of the invention, whether it be wired or wireless.

### Distribution and Processing Portions

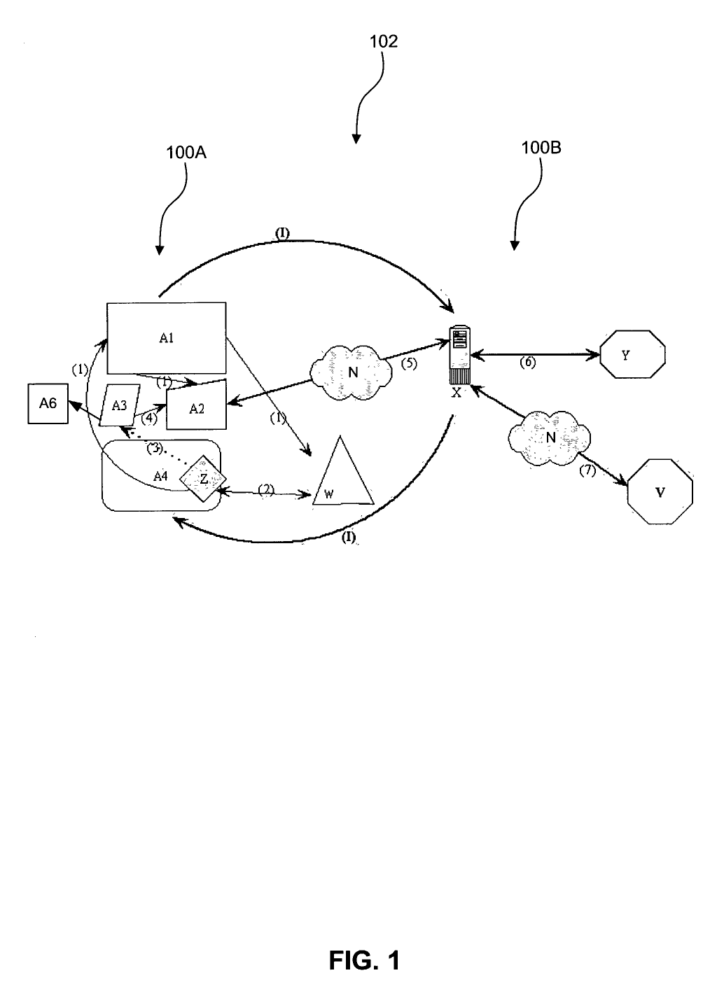

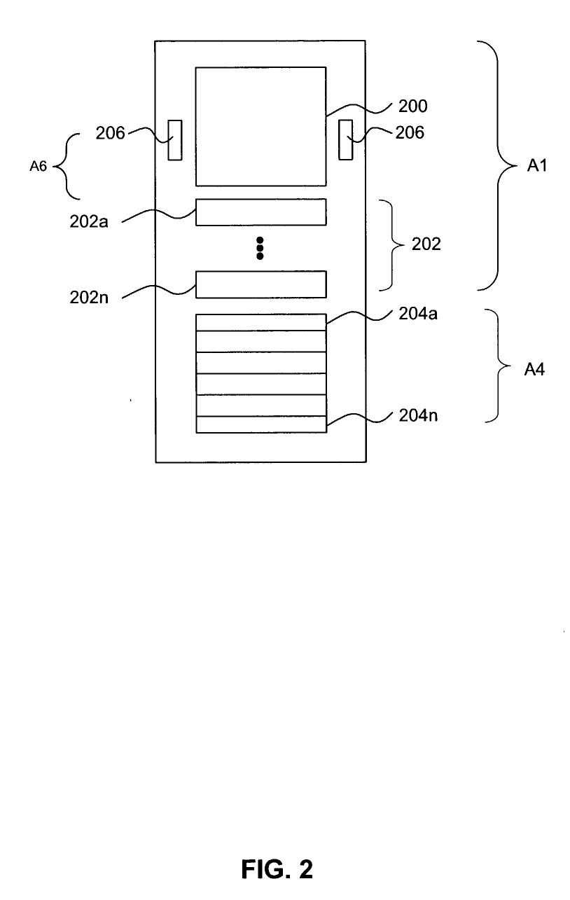

FIG. 1 shows a distribution portion 100A and a processing portion 100B of a system 102 that audits cross platform marketing media according to embodiments of the present invention. Distribution portion 100A includes a display device A1, a reading device A2, a controller A3, a holding device A4, and an audio device A6. A user W interacts with the distribution portion 100A. Holding device A4 can hold materials Z with or embedded with smart tags (FIG. 2) in one or more holding sections (FIG. 2).

FIG. 2 shows a detailed view of display device A1 according to embodiments of the present invention. Display device A1 can be a PerfectCAST™ greeting stand manufactured by I.E. Control Solutions, Inc., which is the subject of U.S. Provisional Appl. No. 60/301,093, filed ______, entitled ______. Display A1 can have a graphical and/or video (hereinafter the combination is discussed as “graphical” only) display area (e.g., an LCD, a GAS Plasma display, or the like) 200 and a textual display area (e.g., one or more LED displays) 202. Textual display area 202 can be coordinated with graphical display area 200 to either translate audio output A6 associated with the graphics or to display additional information associated with the graphics. There may be one or more sections 202a-202n of textual display area 202. For example, graphical display area 200 can be displaying marketing information for an automobile and textual display area 202 can be displaying dealer locations, discounts, financing rates, leasing rates, etc.

With continuing reference to FIG. 2, a detailed view of holding device A4 is also shown according to embodiments of the present invention. Holding device A4, as discussed above, can include one or more holding sections 204a-204n. In some embodiments, one holding section, for example 204a, can hold materials Z that correlate to text shown on one textual display area section, for example 202a, and/or audio output from audio output devices 206 in audio device A6. In other embodiments, each holding section 204 can hold materials A that correlated to an output from graphical display area 200 during a specific time period. For example, if different products are cyclically displayed via display device A1, each product can have associated materials Z in an associated holding sections 204. Also, in some embodiments, by removing materials Z audio device A6 is activated and outputs an audio signal correlating to the removed materials Z. The audio signal can be a sound clip correlating to information on the removed materials Z.

Referring again to FIG. 1, in some embodiments of the present invention, reading device A2 can be a smart tag reader that reads smart tags embedded in materials Z stored in holding device A4. Reading device A2 can be used to count or determine when and how many of materials Z are inserted and removed from holding device A4. A2 can also be used to detect abnormal insertions and removals of materials Z from holding device A4. For example, if after initial insertion a lot of additional materials Z are inserted, someone can be stuffing the holding device A4 with unwanted materials, which must be taken into consideration when generating marketing intelligence I. In other examples, if more than a predetermined number of materials Z are removed at during a predetermined time period, this can indicate an unwanted grabbing of most or all the materials Z, which must be taken into consideration when generating marketing intelligence.

With continuing reference to FIG. 1, in some embodiments of the present invention controller A2 can include a communications device. Controller A2 can transmit and receive communications between distribution portion 100A and processing portion 100B. In some embodiments this can be done via network N (e.g., an internet or intranet network, a wireless link, or the like), while in other embodiments having a one location entity no network is involved just a local system. The signals can be based on information captured by reader A3 during insertion and removal of materials Z from holding section A4. Controller A2 can also include a processor that coordinates and monitors the cross platform media being generated by display device Al. For example, what is being displayed by display section A1 and occurrences of insertion and removal of materials Z from holding section A4 detected by reader A3 can be monitored and a resultant signal based on all these occurrences can be transmitted to processing portion 100B.

Again, continuing to reference FIG. 1, processing portion 100B includes a processor (e.g., a remote or local server) X and a database with software run by the processor. Processor X can be coupled to a materials production and fulfillment facility Y and/or a marketing agent expense calculation system V. Processor X can be coupled to facility Y and/or system V locally or via a network N (e.g., an internet or intranet network).

### Processing and Redemption Portions

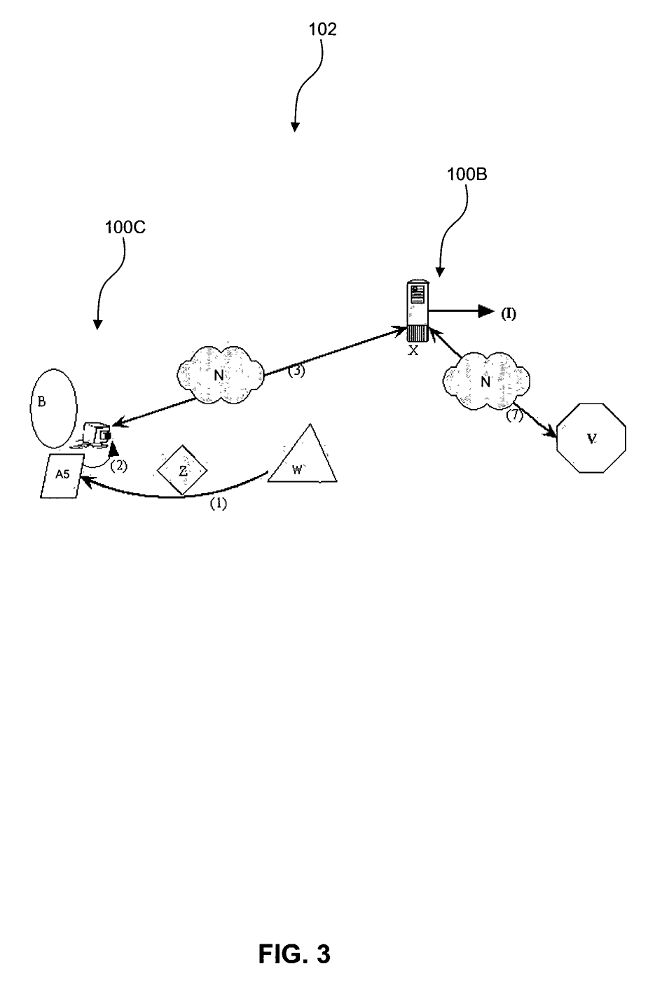

FIG. 3 shows a redemption portion 100C and processing portion 100B in system 102 in according to embodiments of the present invention. In various embodiments, materials Z removed from holding device A4 can be redeemable coupons or vouchers that an issuing entity wants to track for marketing purposes. Redemption portion 100C can include a reader A3 coupled to a controller A5 that reads the smart tag or label embedded in materials Z presented by a user W. Then, controller A5 can generate a resultant signal based on time and place of redemption and information stored in the smart tag or label. The resultant signal can be transmitted to processing portion 100B to be used in conjunction with resultant signals from distribution portion 100C to generate marketing intelligence I. The transmitting can again be local or via a network N. With reference again to FIG. 1, marketing intelligence I can continuously be transmitted between distribution portion 100A and processing portion 100B to most effectively coordinate the cross platform media.

### Overall Methodology for Generating Marketing Intelligence

System 102 shown and described with reference to FIGS. 1-3 above allows for auditing of marketing information to determine a most effective way to market a particular product. In most embodiments, A user W is presented with multiple levels of marketing for each product. This is based on: (1) displaying a general advertisement on display device A1; (2) the user W taking materials Z; (3) audio being output from display device A1; (4) the tracking of materials Z with reader A3 can generate a more specific advertisement on display device A1; (5) the user W reads materials Z one or more times; (6) in some embodiments, user W redeems materials Z at a predetermined location; (7) during redemption, user W can discuss the product with a salesman; (8) after discussing the product, user W can test the product before purchase; and (9) the user W purchases the product. Each of these interactions with the product can be monitored via smart tags and labels, or other devices, and evaluated for their effectiveness in closing a sale of the product. Then, all this information can be processed in processing portion 100B to generate marketing intelligence I, which can then be feedback to several systems to more effective produce, calculate expenses, or display marketing information. This feedback can be done in real time, as discussed above and below. This process can be summarized as (1) impression, (2) recognition, (3) redemption, and (4) intelligence.

The marketing intelligence can be based on demographic information, as well as the raw data from the above process. In various embodiments, variances of the materials Z or the information displayed on display device A1 can be used to further focus a most effective marketing scheme. For example, a value of a coupon or vouchers can be changed over time to see if that effects percentage or redemption and/or percentage of sales. As another example, how many times a materials Z are taken when a certain advertisement is being displayed can be determined.

In another example, charges of every “recognition” and “redemption” event can be set at a certain price level. An application (e.g., a program, software, etc.) running on processor X can calculate in “almost” real time fashion an amount of money charged to advertising clients. A “trigger” (e.g., a threshold value) can be established when a client(s) fails to pay. An instruction can then be sent out to pull materials Z off distribution portion 100A. This will essentially end the promotional campaign based on those materials Z.

These are merely examples of marketing techniques used, while all know and future developed techniques and calculations leading to marketing intelligence are considered to be within the scope of the present invention

### Generating Marketing Intelligence based on having Insertion, Distribution, and Redemption Steps

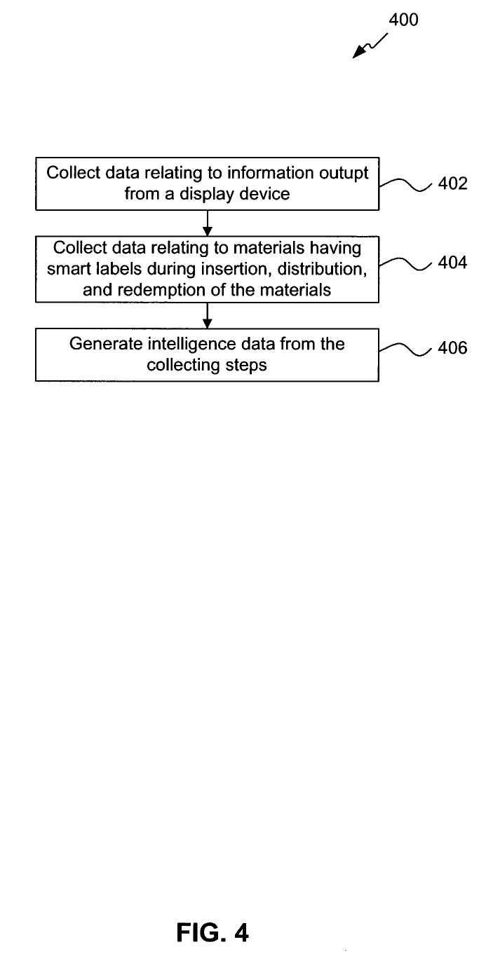

FIG. 4 shows a flow charting depicting a method 400 for generating marketing intelligence according to embodiments of the present invention. At step 402, data relating to information output from a display device is collected. In some embodiments, information output from the display can be cyclically changed. At step 404, data relating to materials having smart labels during insertion, distribution, and redemption of the materials is collected. At step 406, intelligence data is generated based on the data collected in steps 402 and 404.

In various embodiments, step 404 can include collecting data during insertion of materials based on: how many of the materials were inserted in each holding device, how many of the materials were inserted at substantially a same time, how many of the materials were inserted into various holding devices. Other bases for data collection are also contemplated within the scope of the present invention.

In various embodiments, step 404 can include collecting data during distribution of materials can be based on: how many of the materials were removed at substantially a same time, how many of the materials were removed from various holding devices, correlating what type of the materials were taken and what type of the information was being output from the display device at substantially a same time. Other bases for data collection are also contemplated within the scope of the present invention.

In various embodiments, step 404 can include collecting data during redemption of materials based on: a time period between the distribution step and the redemption step, time periods between the distribution step and the redemption step for varying types of the materials, occurrences of the redemption step compared to occurrences of the distribution step, comparing a ratio of occurrences of the redemption step to occurrences of the distribution step for types of the materials, a location of the distribution step compared to a location of the redemption step, time periods between the distribution step and the redemption step for each the distribution step, time periods between the distribution step and the redemption step for various locations of the distribution step, time periods between the distribution step and the redemption step for various locations of the redemption step. Other bases for data collection are also contemplated within the scope of the present invention.

In various embodiments, intelligence data generated during step 406 can be used for: initiating subsequent production of the materials, calculating costs of the materials, determining the most effective ones of the materials, and determining a most effective coordination of the information output and the materials. Other uses of the marketing intelligence are contemplated within the scope of the present invention.

### Methodology for Generating Marketing Intelligence Based On Having Insertion and Distribution Steps

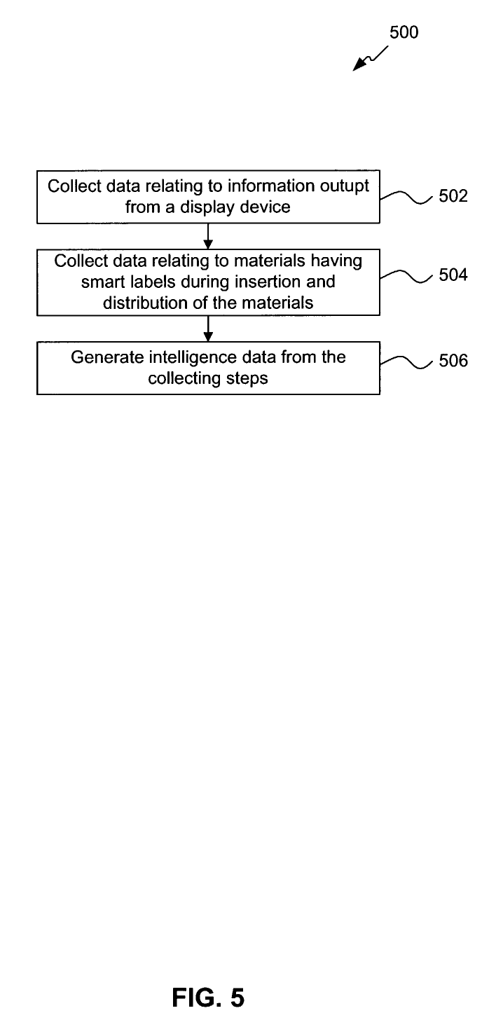

FIG. 5 shows a flow chart depicting a method 500 for generating marketing intelligence according to embodiments of the present invention. At step 502, data relating to information output from a display device is collected. At step 504, collecting data relating to materials having smart labels during insertion and distribution of the materials is collected. At step 506, intelligence data is generated based on collecting steps 502 and 504.

In various embodiments, step 504 can include collecting data during insertion of materials based on: how many of the materials were inserted in each holding device, how many of the materials were inserted at substantially a same time, how many of the materials were inserted into various holding devices. Other bases for data collection are also contemplated within the scope of the present invention.

In various embodiments, step 504 can include collecting data during distribution of materials can be based on: how many of the materials were removed at substantially a same time, how many of the materials were removed from various holding devices, correlating what type of the materials were taken and what type of the information was being output from the display device at substantially a same time. Other bases for data collection are also contemplated within the scope of the present invention.

In various embodiments, intelligence data generated during step 506 can be used for: initiating subsequent production of the materials, calculating costs of the materials, determining the most effective ones of the materials, and determining a most effective coordination of the information output and the materials. Other uses of the marketing intelligence are contemplated within the scope of the present invention.

### Computer System in the Distribution, Redemption, and/or Processing Portions

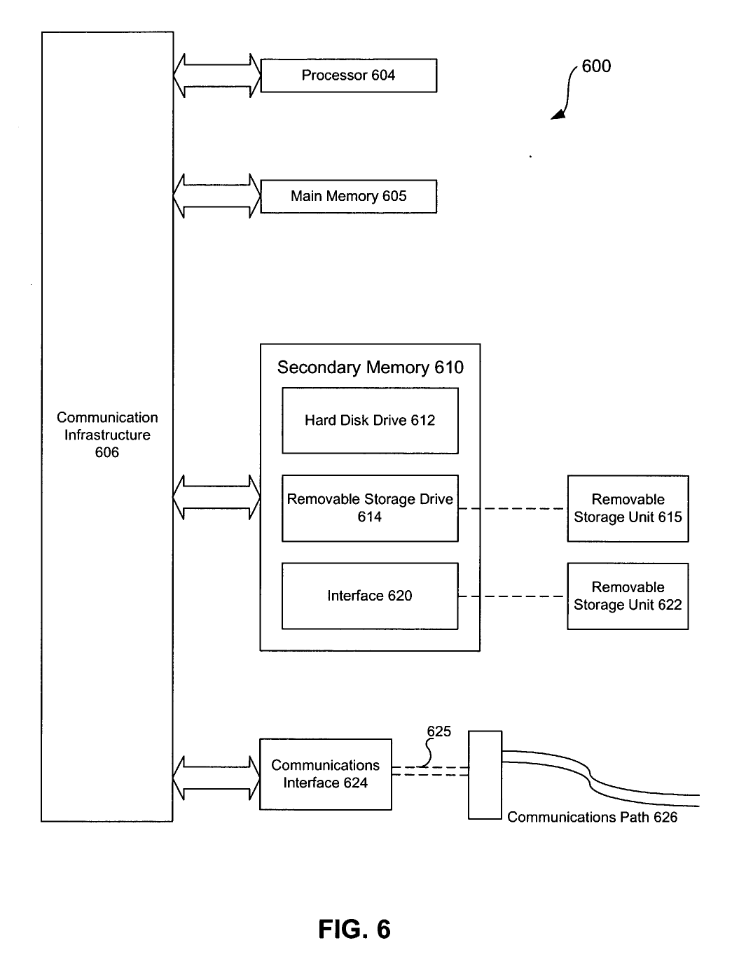

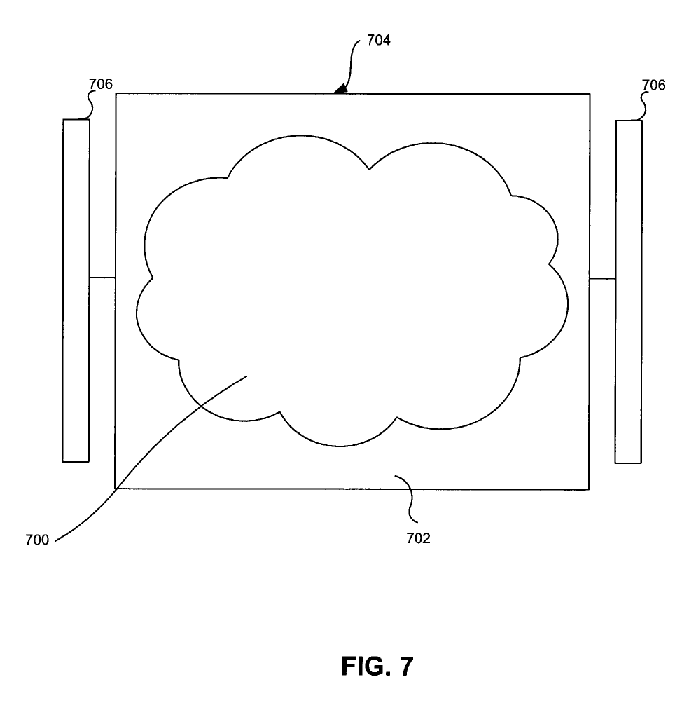

The distribution portion 100A, processing portion 100B, and/or redemption portion 100C can include a computer system in order to perform the various functions described above. For example, FIG. 6 illustrates a computer system 600 that includes one or more processors, such as processor 604, according to embodiments of the present invention. Processor 604 can be a special purpose or a general purpose digital signal processor. The processor 604 is connected to a communications infrastructure 606 (for example, a bus or network). Various software implementations are described in terms of this exemplary computer system. After reading this description, it will become apparent to a person skilled in the relevant art how to implement the invention using other computer systems and/or computer architectures.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a PCMCIA slot and card, etc. Software and data transferred via communications interface 624 are in the form of signals 628 which may be electronic, electromagnetic, optical or other signals capable of being received by communications interface 624. These signals 628 are provided to communications interface 624 via a communications path 626. Communications path 626 carries signals 628 and may be implemented using wire or cable, fiber optics, a phone line, a cellular phone link, an RF link and other communications channels.

In this document, the terms “computer program medium” and “computer usable medium” are used to generally refer to media such as removable storage drive 614, a hard disk installed in hard disk drive 612, and signals 628. These computer program products are means for providing software to computer system 600.

Computer programs (also called computer control logic) are stored in main memory 608 and/or secondary memory 610. Computer programs may also be received via communications interface 624. Such computer programs, when executed, enable the computer system 600 to implement the present invention as discussed herein. In particular, the computer programs, when executed, enable the processor 604 to implement the processes of the present invention, such as the processes 400 and 500 described above. Accordingly, such computer programs represent controllers of the computer system 600. Where the invention is implemented using software, the software may be stored in a computer program product and loaded into computer system 600 using removable storage drive 614, hard drive 612 or communications interface 624.

### Monitoring Marketing Performance Indicators in “Almost” Real-time Based On Marketing Intelligence

FIG. 7 shows system V including an output 700 (e.g., a “Digital Cockpit” or a “Digital Dashboard”) according to embodiments of the present invention. Output 700 can be created on a desktop 702 of a display device 704 used by marketing executives or other senior company executives using system V. Output 700 can graphically and/or textually present key indicators, explanations of the reasons behind generated marketing intelligence numbers, etc. The graphics and/or text of output 700 can be associated with an audio output via audio output device 706 coupled to display device 704.

In some embodiments, marketing intelligence generated and displayed can be related to “recognition events” of materials Z. This can be a decline in “recognition events” in certain locations after, for example, two weeks of showing materials Z, where the locations are normally “stable-traffic” locations. In this case, system 100 can make the connection between the two events (e.g., recognition events drop and location stable traffic location) and generate an output 700 on display device 704 to indicate this to a company executive(s) viewing display device 704. With this information, the company executive can alter what is output and distributed at display device A1.

In various embodiment, key measures to track for marketing intelligence, which can be generated as output 700, and their definitions can be either determined in advance or controlled via system V. Relevant data from various business units can also be integrated. Output 700 can be accessed wherever there is a network N or other connection.

### Example Uses of the Marketing Intelligence Systems and Methods

With reference again to FIGS. 1-3, several example uses of the systems and methods discussed above to gather marketing intelligence are discussed below. Some of the description below contains trademarks or marks of other companies.

### EXAMPLE 1

A video clip can be output from A1 showing a company advertisement (e.g., a PRICELINE.COM advertisement). A consumer W could then remove one of the materials (e.g., a CD) Z stored in holding section A4. Browser software on a computer coupled to the Internet that is operated by consumer W could be automatically directed to a web sit for PRICELINE.COM. Consumer W then could sign on and get a bonus. Marketing intelligence could then be gathered about consumer W, the CD, and the entire transaction based on consumer W using the CD to go to the web site for PRICELINE.COM.

### EXAMPLE 2

Display A1 is outputting a clip of a music video featuring Brittany Spear's new album with no sound. Consumer W can remove one of matarials (e.g., a CD) Z, which contains that particular song. When the CD is removed from holding section A4, display A1 and audio A5 can output “wait till to see the clip of the music video with sound.” Consumer W can insert the CD into a computer coupled to the Internet that is operated by consumer and get a discount towards the purchase of the song either thorugh a printable coupon or purchase over the Internet. In another embodiment, consumer W can present the CD to a cashier B (FIG. 3) in the same store or at a designated music store to get the redemption.

### EXAMPLE 3

A movie production company (e.g., 21 Century Fox, etc) who monitors calculating system V just acquired rights to a possible new hit movie (e.g., Blair Witch III) for $5 million. The production company needs to determine how much to spend, where to spend it, and how to most effectively market the movie. The production company can use PerfectCAST™ to play a clip of the movie in predetermined (e.g., major) markets. Marketing intelligence (e.g., recognition and redemption rates) can be used to determine which markets to focus marketing on and how large an investment in marketing might be needed.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system comprising:
a distribution portion from which materials having smart tags are distributed;
a redemption portion at which said materials having smart tags are redeemed; and
a processing portion that processes information received from said distribution portion and said redemption portion, and that transmits result information to said distribution portion.

2. The system of claim 1, wherein said distribution portion comprises:
a display device that displays information;
a holding device that holds said materials having smart tags;
a reading device that reads said smart tag; and
a controller that monitors said reading device and communicates with said processing portion.

3. The system of claim 2, wherein said display device comprises a first display section and a second display section.

4. The system of claim 3, wherein said first display section is a graphic display section.

5. The system of claim 3, wherein said second display section is a graphic display section.

6. The system of claim 3, wherein said first display section is a graphics display section.

7. The system of claim 3, wherein said second display section is a text display section.

8. The system of claim 3, further comprising a controller coupled to said first and second display devices that coordinates a display from said first and second display devices.

9. The system of claim 2, wherein said reading device reads said smart tag during an insertion of said material.

10. The system of claim 2, wherein said reading device reads said smart tag during removal of said material.

11. The system of claim 2, wherein said reading device reads said smart tag during insertion and during removal of said material.

12. The system of claim 2, wherein said holding device comprises a plurality of holding sections.

13. The system of claim 12, wherein:
said material comprises a different type of material for each of said holding sections.

14. The system of claim 12, wherein said display device periodically displays different information.

15. The system of claim 14, wherein each one of said different type of material corresponds to each one of said different information.

16. The system of claim 1, wherein said redemption portion comprises:
a reading device that reads said smart tag during a redemption process; and
a controller that monitors said reading device and communicates with said processing portion.

17. The system of claim 1, wherein said processing portion comprises a server that has a database and stored software, wherein said stored software is run by said server.

18. The system of claim 1, further comprising a materials manufacturing portion coupled to said processing portion that receives information from said processing portion.

19. The system of claim 1, further comprising a calculating portion coupled to said processing portion that receives information from said processing portion and that calculates predetermined parameters from said information.

20. The system of claim 1, further comprising a network portion wherein said distribution portion and said processing portion are coupled via said network portion.

21. The system of claim 20, wherein said network portion is an Internet.

22. The system of claim 20, wherein said network portion is an Intranet.

23. The system of claim 1, further comprising a network portion wherein said redemption portion and said processing portion are coupled via said network portion.

24. The system of claim 23, wherein said network portion is an Internet.

25. The system of claim 23, wherein said network portion is an Intranet.

26. The system of claim 1, wherein said smart tag comprises a RFID tag.

27. The system of claim 1, wherein said distribution portion is a coordinated media portion that coordinates a graphical display device, a textual display device, and said materials.

28. A system comprising:
a processing portion; and
a distribution portion that communicates with said processing portion, said distribution portion including:
a display device;
a holding device that holds material having smart labels, and
a reading device that reads said smart labels.

29. The system of claim 27, wherein said display device comprises a graphical display section and a textual display section.

30. The system of claim 28, further comprising a controller coupled to said graphical and textual display devices that coordinates information displayed on said graphical and textual display devices.

31. A method comprising the steps of:
collecting data relating to information output from a display device;
collecting data relating to materials having smart labels during insertion, distribution, and redemption of the materials;
correlating the collecting data steps; and
generating intelligence data from said correlating step.

32. The method of claim 30, further comprising the step of changing the information output from the display.

33. The method of claim 30, wherein said collecting data relating to materials step collects data corresponding to how many of the materials were inserted in each holding device.

34. The method of claim 30, wherein said collecting data relating to materials step collects data corresponding to how many of the materials were inserted at substantially a same time.

35. The method of claim 30, wherein said collecting data relating to materials step collects data corresponding to how many of the materials were inserted into various holding devices.

36. The method of claim 30, wherein said collecting data relating to materials step collects data corresponding to how many of the materials were removed at substantially a same time.

37. The method of claim 30, wherein said collecting data relating to materials step collects data corresponding to how many of the materials were removed from various holding devices.

38. The method of claim 30, wherein said collecting data steps collect data correlating what type of the materials were taken and what type of the information was being output from the display device at substantially a same time.

39. The method of claim 30, wherein said collecting data relating to materials step collects data corresponding to a time period between said distribution step and said redemption step.

40. The method of claim 30, wherein said collecting data relating to materials step collects data comparing time periods between said distribution step and said redemption step for varying types of the materials.

41. The method of claim 30, wherein said collecting data relating to materials step collects data corresponding to occurrences of said redemption step compared to occurrences of said distribution step.

42. The method of claim 30, wherein said collecting data relating to materials step collects data comparing a ratio of occurrences of said redemption step to occurrences of said distribution step for types of the materials.

43. The method of claim 30, wherein said collecting data relating to materials step collects data corresponding to a location of said distribution step compared to a location of said redemption step.

44. The method of claim 30, wherein said collecting data relating to materials step collects data comparing time periods between said distribution step and said redemption step for each said distribution step.

45. The method of claim 30, wherein said collecting data relating to materials step collects data comparing time periods between said distribution step and said redemption step for various locations of said distribution step.

46. The method of claim 30, wherein said collecting data relating to materials step collects data comparing time periods between said distribution step and said redemption step for various locations of said redemption step.

47. The method of claim 30, further comprising the step of using the intelligence data to initiate subsequent production of the materials.

48. The method of claim 30, further comprising the step of using the intelligence data to calculate costs of promotions and used as basis for charging the clients.

49. The method of claim 30, further comprising the step of using the intelligence data to determine most effective ones of the materials.

50. The method of claim 30, further comprising the step of using the intelligence data to determined a most effective coordination of the information output and the materials.

51. A method comprising the steps of:
collecting data relating to information output from a display device;
collecting data relating to materials having smart labels during insertion and distribution of the materials;
correlating said collecting data steps; and
generating intelligence data from said correlating step.

52. The method of claim 50, further comprising the step of changing the information output from the display.

53. The method of claim 50, wherein said collecting data relating to materials step collects data corresponding to how many of the materials were inserted in each holding device.

54. The method of claim 50, wherein said collecting data relating to materials step collects data corresponding to how many of the materials were inserted at substantially a same time.

55. The method of claim 50, wherein said collecting data relating to materials step collects data corresponding to how many of the materials were inserted into various holding devices.

56. The method of claim 50, wherein said collecting data relating to materials step collects data corresponding to how many of the materials were removed at substantially a same time.

57. The method of claim 50, wherein said collecting data relating to materials step collects data corresponding to how many of the materials were removed from various holding devices.

58. The method of claim 50, wherein said collecting data steps collect data correlating what type of the materials were taken and what type of the information was being output from the display device at substantially a same time.

59. The method of claim 50, further comprising the step of using the intelligence data to initiate subsequent production of the materials.

60. The method of claim 50, further comprising the step of using the intelligence data to calculate costs of the materials.

61. The method of claim 50, further comprising the step of using the intelligence data to determine most effective ones of the materials.

62. The method of claim 50, further comprising the step of using the intelligence data to determined a most effective coordination of the information output and the materials.

63. The system of claim 2, further comprising an audio device.

64. The system of claim 2, wherein said display device comprises a plurality of display sections.

65. The system of claim 3, wherein said first display section is a video display section.

66. The system of claim 27, wherein said distribution portion further comprises an audio device.

67. The system of claim 27, wherein said display device comprises a video display section and a textual display section.

68. The method of claim 30, wherein said generating step is performed in real time.

69. The method of claim 50, wherein said generating step is performed in real time.
